(19) United States
(12) Patent Application Publication
(10) Pub. No.: US 2003/0220706 A1
(43) Pub. Date: Nov. 27, 2003

(54) Wafer map host system

(76) Inventors: Elmer M. Abenes, Richardson, TX (US); Balamurugan Subramanian, Plano, TX (US); James R. Calles, Tucson, AZ (US)

Correspondence Address: TEXAS INSTRUMENTS INCORPORATED, P O BOX 655474, M/S 3999, DALLAS, TX, 75265

(21) Appl. No.: 10/153,664

(22) Filed: May 24, 2002

(51) Int. Cl. G06F 19/00

(52) U.S. Cl. 700/96

(57) ABSTRACT

A wafer map host system and methodology that supports the use of and manipulation of wafer map information for multiple semiconductor processes is disclosed. The system includes a database for storing wafer maps; an interface for providing interfaces to a plurality of wafer manufacturing processes and/or equipment; and a wafer map processor coupled between said database and said interface for managing relationships of various tasks during a wafer map data transaction between the processes and/or equipment and the database. The tasks include deciding which wafer map is required, which equipment is involved, what is the manufacturing flow being used, how to re-map the various bin assignments considering the next manufacturing process, and merging two or more wafer map data for the next manufacturing process.

### FIELD OF INVENTION

This invention relates to a wafer map host system and more particularly to a system architecture and methodology that supports the use and manipulation of wafer map information for multiple semiconductor manufacturing processes and/or equipment.

### BACKGROUND OF INVENTION

The assembly manufacturing sites receive wafers from the wafer fabs, segregate the individual chips from each wafer, encapsulate the chips, and perform final tests before shipping the devices to the customers. The die bonding process where only good chips from a wafer are picked up is conventionally done by the ink dot mechanism. The die bonder steps through each die on a wafer to detect and skip the ink-reject chips and only mount onto the leadframe the un-inked, good chips. With the improvements in process, equipment, and systems, we now have the opportunity to totally eliminate the ink-based process with the use of wafer maps.

In an Assembly/Test (A/T) facility, wafer maps are normally received from off site locations such as wafer fab or probe sites. A wafer map originates from the wafer fab on a tester or wafer mapper equipment at the probe process. FIG. 1 illustrates a wafer map host overview. A wafer map is a set of information that is used by process equipment when handling a wafer at its work station. See FIG. 2 for a pictorial representation of a wafer map. The map data includes the coordinates of each die on a wafer, bin assignments for good dies and reject dies, wafer orientation or rotation, and the wafer identification that is used to associate the wafer map with the physical wafer.

A tester/wafermapper at a Wafer Fab/Probe site does the wafer map data collection A binary wafer map file is uploaded to the test system and collected in a wafer map database. A program on the test system reformats the wafer map into an ASCII file and uploads them on a regular basis into the mainframe wafer map database. Based on the lots that go to a particular Assembly/Test (A/T) site, the wafer map is downloaded in to a wafer map inkless system host. The wafer map host system receives the map data, provides storage, and enables data download into the production equipment to support inkless processing of wafers to manufacture a semiconductor product. The wafer map host system transforms the lot's wafer map ASCII file into each wafer's binary image file that is suitable for the die bonders to handle and prepares them for equipment download. In the manufacturing floor, as the wafer goes through the assembly process, a bar-code is generated for the wafer identification (ID) or the flexframe ID and is attached to the wafer. When the wafer is ready to be processed at the die bonder, the flexframe or wafer ID bar-code is scanned and is used to request the wafer map from the wafer map host system. The die bonder equipment uses the downloaded wafer map to directly step into the good chips for pick-up.

Current wafer map host systems receive wafer map data from an off site facility, parse and store them, and translate them into different formats that are suitable for on site processing. Normally, in a manufacturing facility, only one process area is supported by a wafer map host system.

In the existing method a wafer map data of a wafer is generated by one manufacturing process and used by another manufacturing process. In the new package development environments many manufacturing processes use wafer map data generated by the previous process and modify wafer map data to use other manufacturing processes. Other manufacturing processes within a facility are now enabled for wafer map handling as part of their functional capability.

It is desirable to provide an architecture that will support multiple inline production processes that use and manipulate a wafers' wafer map that go through the manufacturing flow for each product.

### SUMMARY OF INVENTION

In accordance with one embodiment of the present invention a host system architecture is provided that offers flexibility in defining and configuring various elements involved in handling wafer map in a workflow.

In accordance with an embodiment of the present invention a wafer map host architecture is designed to support different product types going through various manufacturing and/or equipment flows.

In accordance with another embodiment of the present invention a wafer map host system is provided to support various sets of processes.

In accordance with another embodiment of the present invention a wafer host system is provided to support different bin mapping setups.

In accordance with one embodiment of the present invention a wafer map host system is provided that provides interfaces between a plurality of manufacturing processes and/or equipment for processing a wafer and wafer map data to send the wafer map data to the processes and/or equipment and receive updated wafer map data from the processes and/or equipment and make the wafer map updates available to the other manufacturing processes and/or equipment.

### DESCRIPTION OF DRAWING

FIG. 1 illustrates wafer map host system overview.

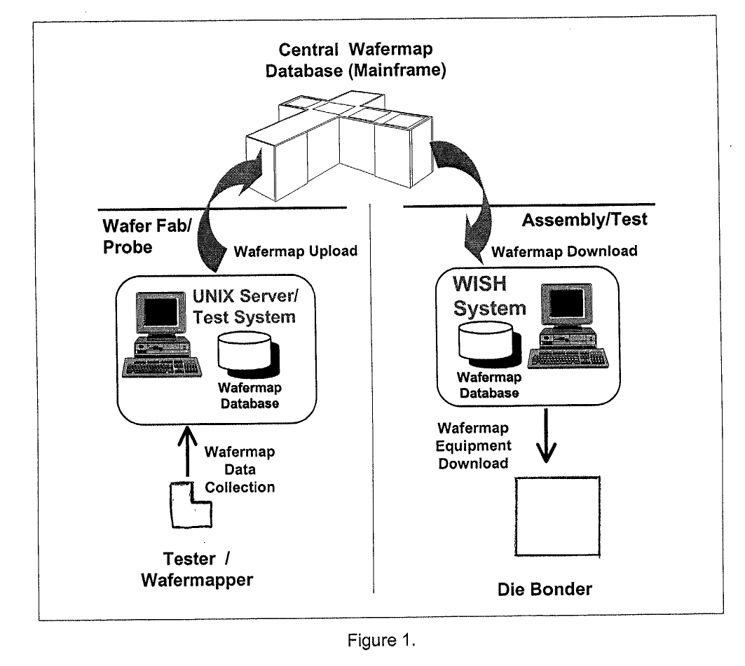

FIG. 2 illustrates a wafer map.

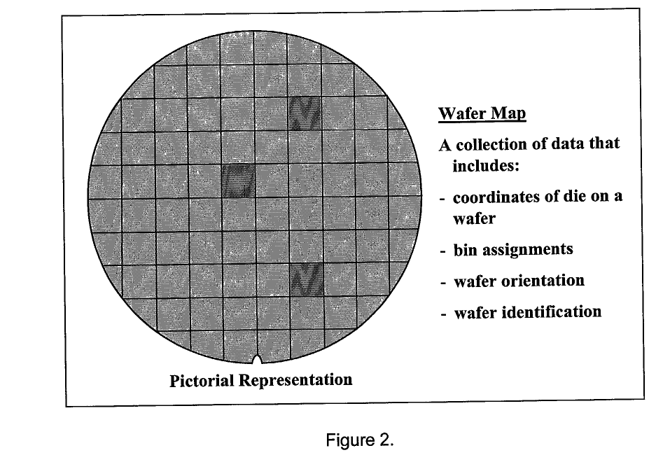

FIG. 3 illustrates current wafer map data flow.

FIG. 4 illustrates wafer map data flow for multiple inline processes according to one embodiment of the present invention.

FIG. 5 is a block diagram of the wafer map system architecture according to one embodiment of the present invention.

FIG. 6 illustrates wafer map bin configuration.

FIG. 7 illustrates process work flow configuration.

FIG. 8 illustrates the process configuration.

FIG. 9 illustrates the product type configuration.

FIG. 10 illustrates the equipment configuration.

FIG. 11 shows the lot definition.

FIG. 12 illustrates a sample wafer map process flow (1) (for Device X).

FIG. 13 is a wafer map process flow chart (wafer map loading).

FIG. 14 is a wafer map process flow chart (wafer map download/upload).

FIG. 15 is a wafer map process flow chart (wafer map download/upload continuation.

FIG. 16 is a sample wafer map process flow (2) (for Device Y).

### DESCRIPTION OF PREFERRED EMBODIMENT OF THE PRESENT INVENTION

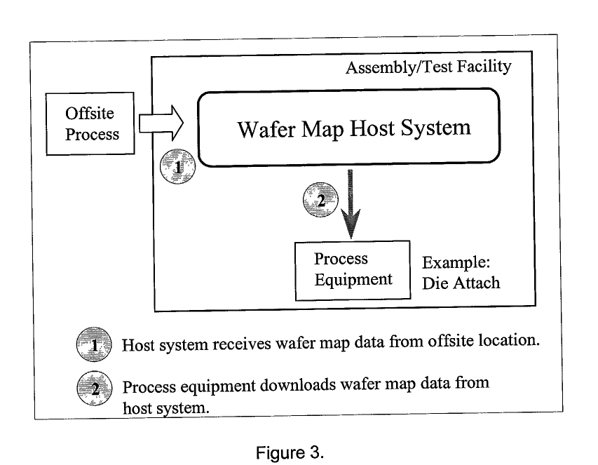

The existing implementation of a wafer map host system supports only one manufacturing process or equipment area as illustrated by the two step process in FIG. 3. In the Assembly/Test facility (A/T) this manufacturing equipment is normally the Die Attach operation or the Tape & Reel operation. In Step 1 the host system receives the wafer map data from an offsite location and in Step 2 the process equipment downloads wafer map data from the host system.

When a wafer is presented to the equipment's work area, a wafer map download is initiated to the host system. Using the wafer's scribed identification (wafer id) the wafer map is looked up and extracted from database storage and transferred to the equipment. The wafer map includes the bin assignments and coordinate information of the dies in the wafer and enables the equipment to decide to process only the known good dies.

In new package development environment, various manufacturing process steps and/or equipment now have the capability to use wafer map data and also to update them based on the operational functions of the manufacturing process and/or equipment. Manufacturing processes like visual inspection can modify the original wafer map and can make modified wafer map data available to other subsequent manufacturing processes and/or equipment that handles the wafer. The ability of a host system to send and then to receive an updated wafer maps from a manufacturing process and/or equipment and make it available to other manufacturing processes is provided by the present invention.

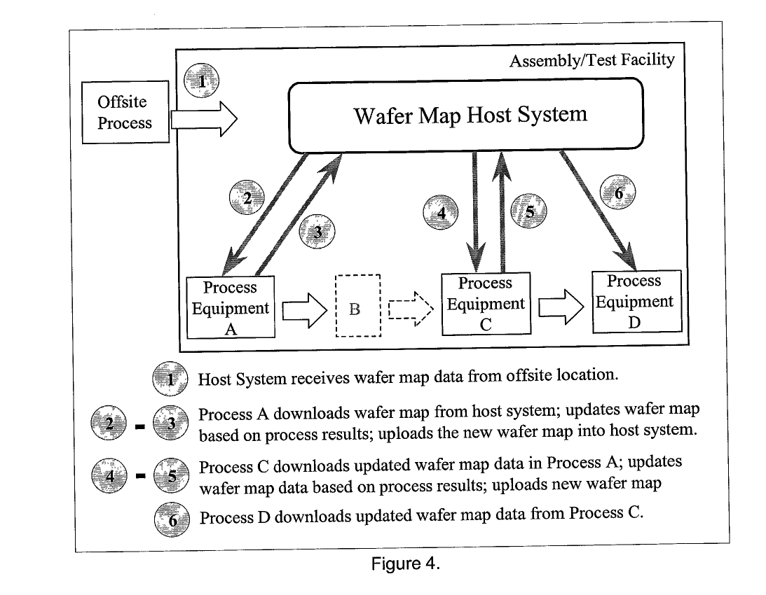

Consider three manufacturing processes, Process A, C and D, that a certain wafer will go through in the manufacturing operation as shown in FIG. 4. The host system receives the wafer map data from the off site location at Step 1. When the wafer is at manufacturing Process A, equipment A downloads the wafer map data from the host system at Step 2; uses the data to complete its operations (like symbolize, test, or inspect) and modifies or updates the wafer map data based on process results, and uploads this new wafer map information back to the host system at Step 3. The host system receives the updated wafer map data from Process equipment A and prepares this for the next inline process for the same wafer. Manufacturing Process C, the next operation that is wafer map enabled, will perform similar map download by downloading updated wafer map data in Process A at Step 4, updating wafer map data based on process results in Process C and upload in Step 5 new wafer map into the host system. Manufacturing Process D will use the last updated wafer map data from the manufacturing Process C for its operation. The manufacturing process may include different equipment and the host system will enable the same sending and receiving of updates between equipment.

A system architecture that offers flexibility in defining and configuring various elements involved in handling wafer map in a workflow is provided herein. The new wafer map host architecture is a) designed to support different product types going through various manufacturing and/or equipment flows, b) use various sets of processes, and c) support different bin mapping setups.

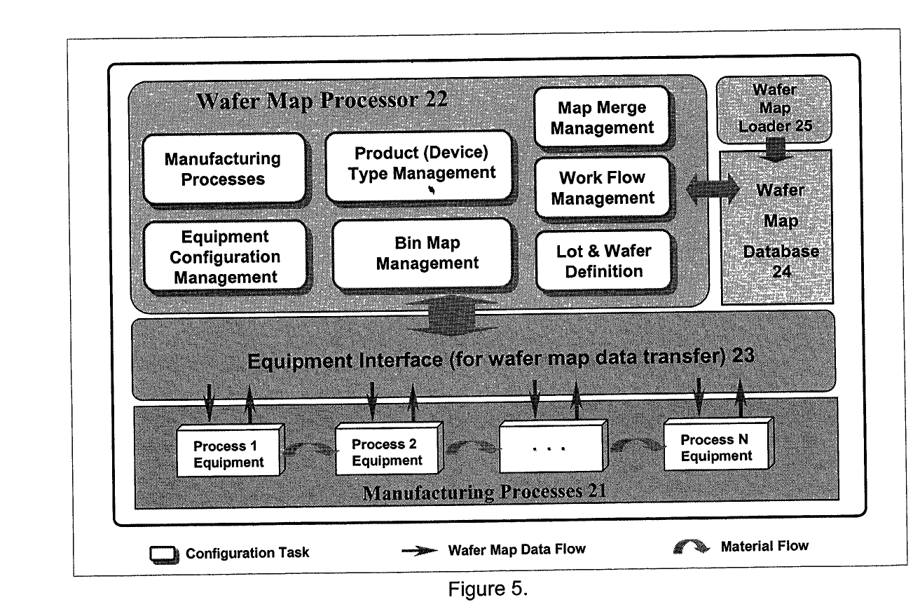

The wafer map system architecture 20 according to one embodiment of the present invention is illustrated in FIG. 5. The wafer map system architecture 20 includes manufacturing processes 21; wafer map processor 22; equipment interface 23 (for wafer map data transfer) between the wafer map processor 22 and manufacturing processes 21; a wafer map database 24; and a wafer map loader 25. The manufacturing processes 21 includes Process 1 equipment and Process 2 equipment through Process N equipment. The wafer map database 23 is used to store all of the wafer map related information. This includes the original wafer maps that arrive from the off site location (via the loader 25), updated wafer maps from the manufacturing processes and/or equipment, and the definition, configuration, and relationships of the various map-related components and tasks listed below:

lot and wafer definition

product (device) type management

manufacturing process work flow definitions

bin map management

wafer map merge management

manufacturing process definition and

management of equipment identification and their respective types.

The wafer map processor 22 is the heart of this architecture and manages the relationships of the various tasks during a wafer map data transaction. Each of the processor 22 tasks gets involved in deciding which wafer map is required, which equipment is involved, what is the manufacturing flow being used, how to re-map the various bin assignments considering the next manufacturing process and merging two or more wafer map data for the next manufacturing process.

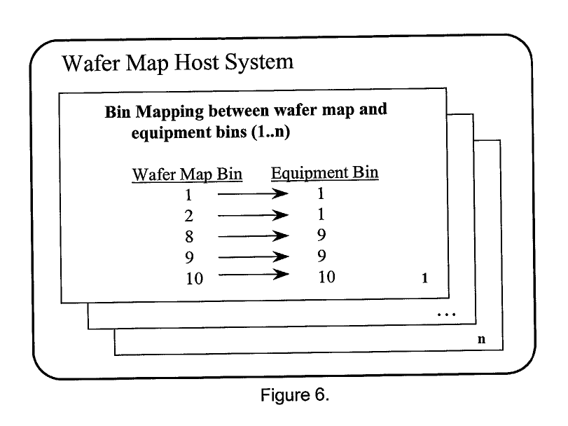

When the wafer map is prepared for a manufacturing process that uses a specific equipment type, a re-mapping of the wafer map bins against the equipment bins is done. The bin-mapping configuration defines the different ways to associate a wafer map bin into equipment bin. (FIG. 6) It is possible to associate several wafer map bins into one equipment bin. These bin mapping definitions are used when setting up all the possible manufacturing work flows that will be used that will be used in the facility.

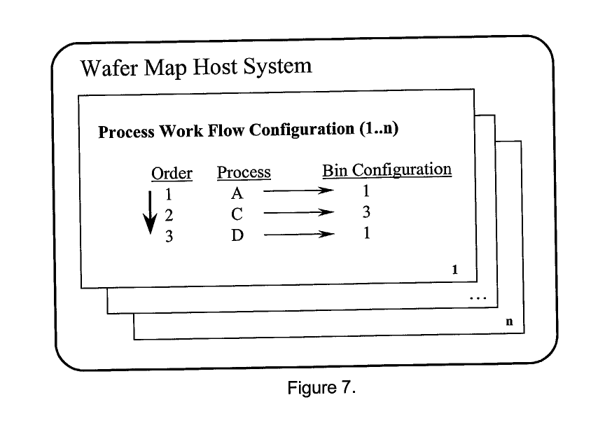

A particular manufacturing workflow will be assigned to a particular product type with the existing manufacturing process equipment. There may be various manufacturing workflows for different product types. A workflow configuration should be defined before hand in order to associate this to a product type. Workflow definitions include the different sets of possible combinations of manufacturing process (operations) and their respective order in the manufacturing wafer flow, as well as the bin mapping information that will be associated with each operation. See FIG. 7, which illustrates work order and for each process the bin configuration. For Process C the bin configuration is changed from 1 to 3 and for Process D the bin configuration is changed back to 1. When wafer map data is prepared for the manufacturing operation, the workflow that is associated with the material is used to determine where the wafer is coming from and which process it is going next. This association may be traced to the relationships of the wafer with the lot, the product type where the lot is categorized, and the workflow that is defined for the product.

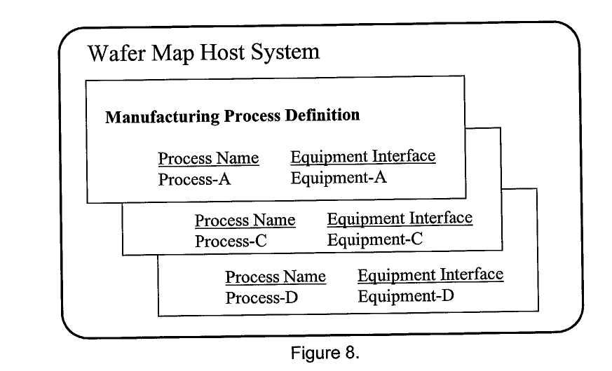

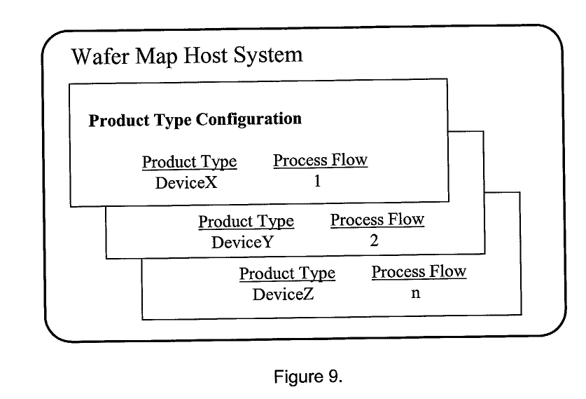

The product (device) type management task is a configuration tool to define the product types (devices) that are manufactured in the facility and define which manufacturing process flow is used. FIG. 8 illustrates a process configuration with for each process name an assigned equipment interface such as for Process A the equipment interface for Equipment A, Process C the equipment for equipment C, etc. A product type must be configured before the product type goes through the manufacturing operation. See FIG. 9 for product type configuration. Assigning a workflow configuration for each product type ensures that all wafer map data associated with a product type (device) will follow consistent wafer map handling. For example, for Product type DeviceX the process flow is 1.

One or more wafers associated to a product type (device) and the device definition enables a common and consistent manufacturability of a certain product. A lot is composed of one or more wafer maps that support the processing of wafers in a batch.

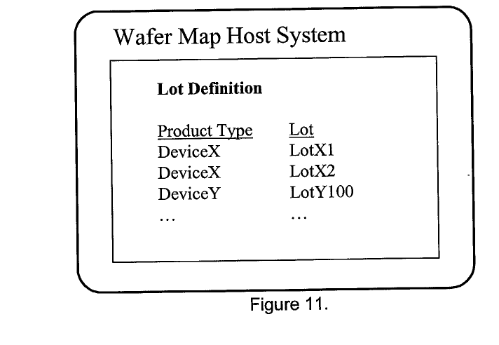

The lot definition includes identification of the various wafer maps associated with the lot, and the product or the device type that is associated to the lot. See FIG. 11 that illustrates for a product type the lot definition such as LotX1 for product type DeviceX. A wafer is associated with its wafer map information using the wafer-scribed identification.

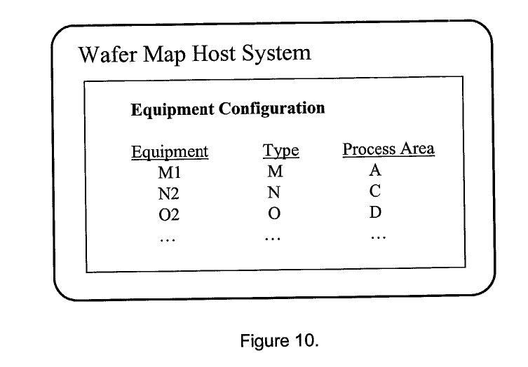

The equipment configuration management defines the various manufacturing process equipment to certain types, and associates each type to a manufacturing process. See FIG. 10 where, for example, for equipment M1 the type is M and the process area is A. These relationships are used by the equipment interface during the transfer of wafer map data between the host system and the equipment.

The purpose of map merge management is to merge two or more wafer map data of previous processes into a single wafer map data for the next subsequent processes.

The purpose of wafer map loader is to import different kinds of wafer map data format into the database and also enable the export of the internal wafer map data into various formats for off site purposes.

The various tasks and components in the architecture work together to support the data flow of wafer maps as well as the communication between the host system and the equipment.

When a wafer map transfer is initiated from the process equipment 21, the equipment interface program 23 serves the request and handles the data communication with the host system. See FIG. 5. Using the wafer's scribed identification, the wafer map processor 22 identifies the wafer map data that needs to be downloaded to or that was sent from the process equipment 21 (Process 1, Process 2, etc.).

When a wafer map upload request is sent by process equipment, the wafer identification is used to look up the lot and product type associated with the wafer. Using the product type, the workflow for the device is then determined and the processes involved in the manufacturing flow are identified. The equipment, current process area, and device workflow are used to identify the wafer map in the system.

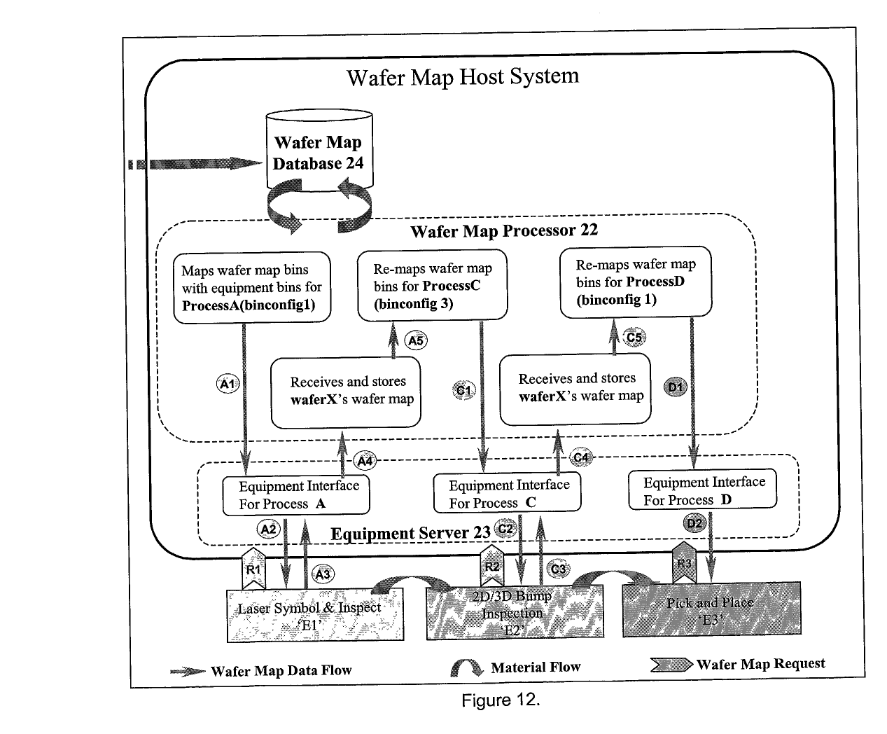

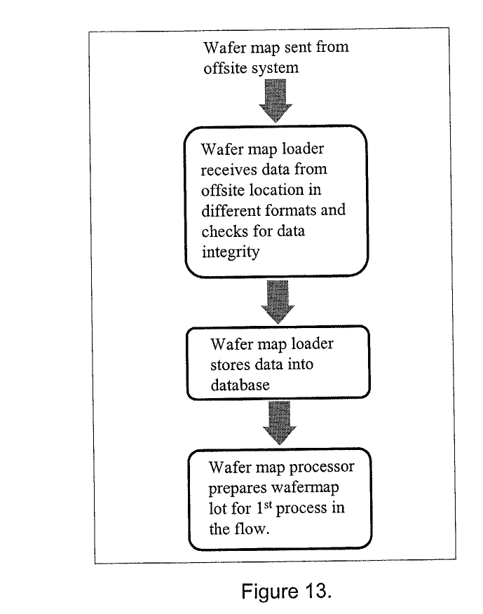

FIG. 12 illustrates a detailed wafer map communication scenario. Workflow 1 consists of the following three manufacturing processes: A for Laser Symbol & Inspect, C for 2D/3D Bump Inspection, and D for Pick and Place. In this work flow definition, Processes A and D use bin mapping configuration “1” while Process C uses bin mapping “3”. WaferX going through the manufacturing operations for product type “DeviceX”. When the wafer map gets to the host system, the various information regarding the device, workflow, associated processes, and the bin maps to be used are collected. The wafer map processor 22 then uses these data to map the wafer map bins into the equipment bins for the first process equipment in the flow (FIG. 13) where the wafer map loader receives the data from off site location in different formats and checks for data integrity, stores the data into the database, and the wafer map processor then prepares the wafer map lot for first process in the flow.

When the physical wafer goes to the Laser Symbol & Inspect, a wafer map data download request ‘R1’ is initiated. The wafer map is extracted from the database 24 and gets transferred to the equipment through the wafer map processor 22 and the equipment interface 23 for Process A (A1 to A2). The wafer goes through symbol marking and inspection operations and the equipment ‘E1’ updates the wafer map based on the inspection results. Equipment ‘E1’ uploads the updated wafer map to the host system (A3-A5). The new wafer map is stored back into the database 24 and is prepared for the next process in the workflow. This preparation includes re-mapping of the bins and also designating the wafer map with the next associated process area.

The next operation of 2D/3D Bump inspection follows the same steps requesting for wafer map (‘R2’) receives the wafer map from the host (C1-C2) and then uploads back an updated wafer map (C3-C5) after bump inspection. The last process, Pick and Place, downloads a wafer map that was updated by the previous process in the flow (R3, D1-D2).

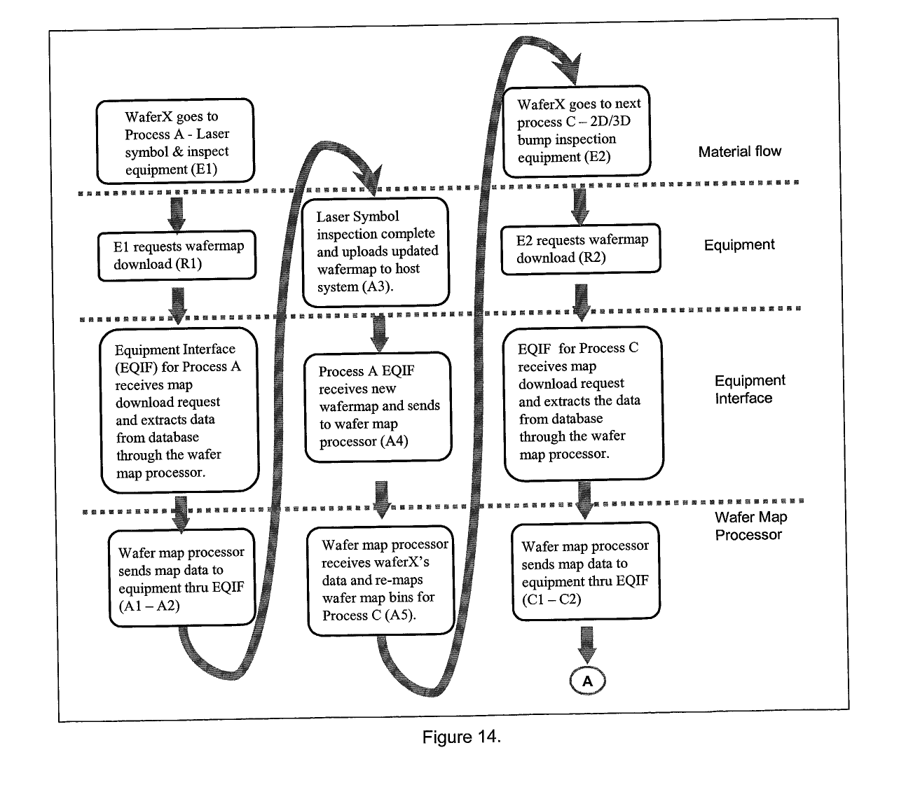

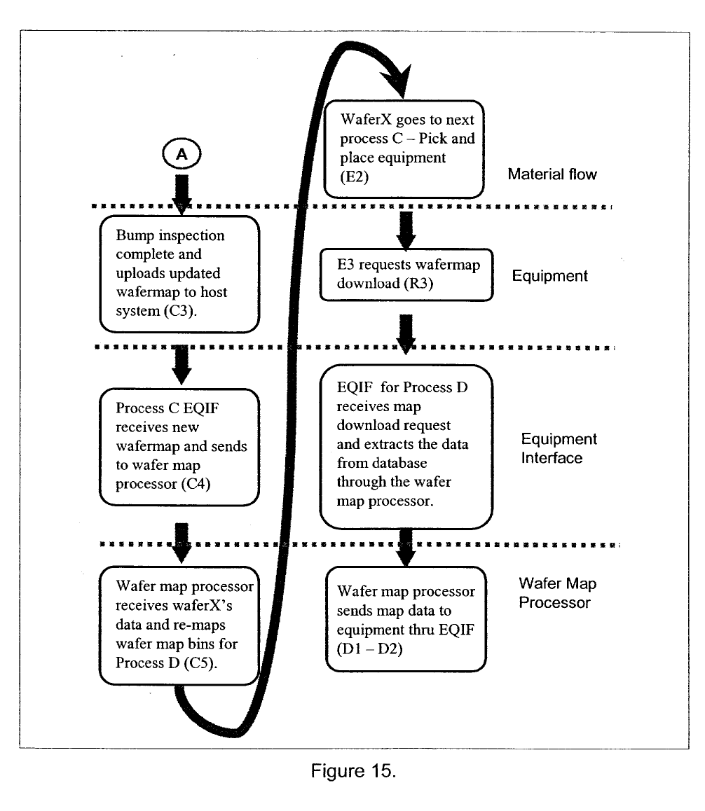

The preceding steps are also illustrated in the flow chart shown in FIGS. 14 and 15. The WaferX goes to Process A—Laser symbol & inspect equipment El. The equipment E1 requests the wafer map download (R1). The equipment interface for Process A receives the map download request and extracts data from the database through the wafer map processor. The wafer map process sends the map data to the equipment through the equipment interface. The laser symbol inspection is completed and uploads updated wafer map to the host system A3. The equipment interface receives the new wafer map and sends it to the wafer map processor. The wafer map processor receives WaferX's data and re-maps wafer map bins for Process C (A5). The WaferX goes to the next Process C which is the 2D/3D bump inspection at equipment E2. Equipment E2 requests wafer map download (R2). The equipment interface for Process C receives map download request and extracts the data from the database through the wafer map processor. The wafer map processor sends map data to equipment through the interface (C1-C2).

FIG. 15 continues on the process to perform the bump inspection and upload the wafer map to host system (C3). The Process C interface receives new wafer map and sends that to wafer map processor (C4). The wafer map processor receives WaferX's data and re-maps wafer map bins for Process D. WaferX goes to next Process D-Pick and Place equipment (E3). Equipment E3 requests wafer map download (R3). The equipment interface for Process D receives map download request and extracts the data from database through the wafer map processor. The wafer map processor sends map data to equipment through the interface (D1-D2).

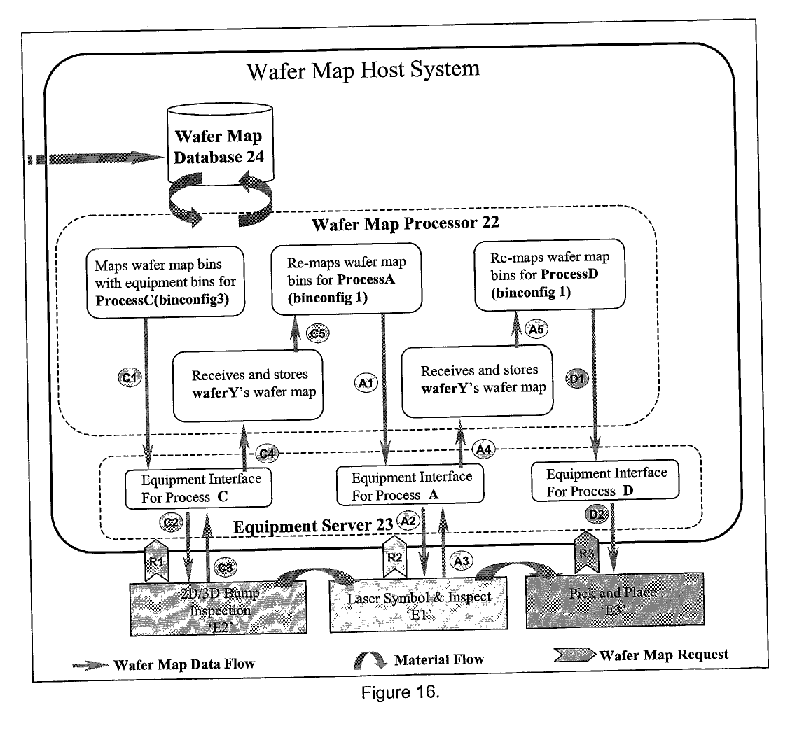

Another example is for WaferY of product type DeviceY as shown in FIG. 16. The inline processes in the work flow starts with the 2D/3D Bump inspection (E2) process first, followed by Laser Symbol & Inspect (E1), and finally the Pick & Place process (E3). Based on this work flow, the wafer map gets prepared differently in terms of bin mapping and designation of the process areas that will request for wafer map download (R1, C1-C2, and R2, A1-A2), and upload (C3-C5 and A3-A5).

Although certain embodiments of the present invention have been described herein, one of ordinary skill will realize numerous variations and modifications are possible without departing from the spirit of the present invention. Accordingly, reference should be made to the appended claims to determine the scope of the present invention.

In the claims:

1. A wafer map host system comprising:
a database for storing wafer maps;
an interface for providing interfaces to a plurality of wafer manufacturing processes and/or equipment; and a
wafer map processor coupled between said database and said interface wherein various manufacturing process steps and/or equipment use wafer map data and update the data based on the operational functions of the plurality of manufacturing processes and/or equipment.

2. The system of claim 1 wherein said wafer map processor system provides flexibility in defining and configuring various elements involved in handling wafer map in a workflow.

3. The system of claim 1 wherein said wafer map processor supports different bin mapping setups.

4. The system of claim 1 wherein said wafer map processor performs manufacturing process work flow definitions.

5. The system of claim 1 wherein said wafer map processor performs wafer map merge management.

6. The system of claim 5 wherein said wafer map processor supports different bin mapping setups.

7. The system of claim 6 wherein said wafer map processor performs manufacturing process work flow definitions.

8. The system of claim 1 wherein said wafer map processor performs the following tasks:
lot and wafer definition,
product (device) type management,
manufacturing process work flow definitions,
bin map management,
wafer map merge management,
manufacturing process definition, and
management of equipment identification and their respective types.

9. A wafer manufacturing method that provides flexibility in defining and configuring various elements in a wafer map in a workflow comprising the steps of:
providing a plurality of manufacturing processes and/or equipment of a wafer;
receiving wafer map data at one of said manufacturing processes and/or equipment;
performing said manufacturing and/or equipment processes; and
updating said wafer map and sending said updated wafer map from said manufacturing process and/or equipment and making it available to the other manufacturing processes and/or equipment in the work flow.

10. The method of claim 9 wherein said updating step includes bin map management.

11. The method of claim 9 wherein said updating step includes wafer map management.

12. The method of claim 9 wherein said updating step includes manufacturing process work flow definitions.

13. A wafer map host system comprising:
a database for storing wafer maps;
an interface for providing interfaces to a plurality of wafer manufacturing processes and/or equipment; and
a wafer map processor coupled between said database and said interface for managing relationships of various tasks during a wafer map data transaction between the processes and/or equipment and the database.

14. The system of claim 13 wherein said tasks include deciding which wafer map is required.

15. The system of claim 13 wherein said tasks include which equipment is involved.

16. The system of claim 13 wherein said tasks include what is the manufacturing flow being used.

17. The system of claim 13 wherein said tasks include how to re-map the various bin assignments considering the next manufacturing process.

18. The system of claim 13 wherein said tasks include merging two or more wafer map data for the next manufacturing process.

19. The system of claim 13 wherein said tasks include deciding which wafer map is required, which equipment is involved, what is the manufacturing flow being used, how to re-map the various bin assignments considering the next manufacturing process, and merging two or more wafer map data for the next manufacturing process.
